(19) United States
(12) Patent Application Publication
(10) Pub. No.: US 2009/0089420 A1
(43) Pub. Date: Apr. 2, 2009

(54) Flash tracking system and method

(76) Inventors: Michael Caruso, Oakland, CA (US); Mikhail Ledvich, Bridgeport, CT (US)

Correspondence Address: DUANE MORRIS LLP - San Diego, 101 WEST BROADWAY, SUITE 900, SAN DIEGO, CA, 92101-8285, US

(21) Appl. No.: 11/906,294

(22) Filed: Oct. 1, 2007

(51) Int. Cl. G06F 15/173

(52) U.S. Cl. 709/224

(57) ABSTRACT

A system, method and computer readable medium configured to track Internet users as they browse web-sites when cookies are disabled or deleted. One aspect of the present invention includes the realization that cookies are not adequate to track Internet web users as cookies are limited and size, and easily deleted by users. A web-site receives a request for content from the computing-device. After obtaining information about the computing-device, the tracking-server assesses the request for content from the computing-device. If the computing-device has an available flash plug-in, the tracking-server transmits a flash applet to the computing-device. The flash applet is configured to: determine whether a unique flash identifier has been assigned to the computing-device, generate the unique flash identifier if no unique flash identifier has already been assigned to the computing-device, transmit the unique flash identifier to a tracking server, and store the unique flash identifier in local flash storage. The process also stores a cookie at the computing-device when no flash plug-in is available.

### BACKGROUND

1. Field of the Invention

Aspects of the present invention relate in general to electronic/Internet advertising. Specifically, aspects include a method, system, and computer-readable medium configured to track Internet users as they browse web-sites on the Internet.

2. Description of the Related Art

In March, 1989, the European Laboratory for Particle Physics or CERN (Conseil Europeen pour la Recherche Nucleaire) developed the World-Wide-Web (WWW, or simply, “the web”), an Internet-based computer network that allows users on one computer to access information stored on other computers through a world-wide network. With an intuitive user-interface, known as a web browser, the web rapidly became a popular way of transmitting and accessing text and binary information. Since then, there has been a massive expansion in the number of World-Wide-Web sites, and the amount of information placed on the web.

The web is built on a very simple, but powerful premise. All material on the web is formatted in a general, uniform format called HTML (Hypertext Markup Language), and all information requests and responses conform to a similarly standard protocol. When someone accesses a server on the Web, such as the Library of Congress, the user's Web browser will send an information request to the Library of Congress' computer. This computer is called a web server. The web server will respond to the request by transmitting the desired information to the user's computer. There, the user's browser will display the received information on the user's screen.

Cookies are information generated by a web server and stored in the user's computer, ready for future access. Cookies are embedded in the HTML information flowing back and forth between the user's computer and the servers. Cookies were implemented to allow user-side customization of Web information. For example, cookies are used to personalize Web search engines, to allow users to participate in web contests, and to store shopping lists of items a user has selected while browsing through a virtual shopping mall.

Essentially, cookies make use of user-specific information transmitted by the Web server onto the user's computer so that the information might be available for later access by itself or other servers. In most cases, not only does the storage of personal information into a cookie go unnoticed, so does access to it. Web servers automatically gain access to relevant cookies whenever the user establishes a connection to them, usually in the form of Web requests.

Cookies are based on a two-stage process. First the cookie is stored in the user's computer. For example, with customizable web search-engines, a user selects categories of interest from the web page. The web server then creates a specific cookie, which is essentially a tagged string of text containing the user's preferences, and it transmits this cookie to the user's computer. The user's web browser, if cookie-savvy, receives the cookie and stores it in a special file called a cookie list. With most web-browsers, this happens without any notification or user consent. As a result, personal information (in this case the user's category preferences) is formatted by the web server, transmitted, and saved by the user's computer.

During the second stage, the cookie is clandestinely and automatically transferred from the user's machine to a web server. Whenever users direct their web browser to display a certain Web page from the server, the browser will, without user knowledge, transmit the cookie containing personal information to the Web server.

With some web browsers, users have the option of turning off or deleting their cookies. When this happens, web servers are unable to track users or set up customized content for users.

### SUMMARY

Embodiments of the invention include a system, method and computer readable medium configured to track Internet users as they browse web-sites without cookies. Initially, a web-site receives a request for content from the computing-device. The web-site obtains information about the computing-device, and assesses the request for content from the computing-device. Next, the method embodiment determines whether the computing-device has an available flash plug-in. If so, the tracking-server transmits a flash applet to the computing-device. The flash applet is configured to: determine whether a unique flash identifier has been assigned to the computing-device, generate the unique flash identifier if no unique flash identifier has already been assigned to the computing-device, transmit the unique flash identifier to a tracking server, and store the unique flash identifier in local flash storage. The process also stores a cookie at the computing-device when no flash plug-in is available.

### BRIEF DESCRIPTION OF THE DRAWINGS

FIG. 1 illustrates an embodiment of a system configured to track Internet users as they browse web-sites on the Internet without using cookies.

FIG. 2 depicts a detailed embodiment of a system configured to track Internet users as they browse web-sites on the Internet without using cookies.

FIG. 3 is a flowchart of a method embodiment to track Internet users as they browse web-sites on the Internet without using cookies.

FIGS. 4A-B are a flowchart of an alternate method embodiment to track Internet users as they browse web-sites on the Internet without using cookies.

### DETAILED DESCRIPTION

One aspect of the present invention includes the realization that cookies are not adequate to track Internet web users as cookies are limited and size, and easily deleted by users. What is needed is a system and method of tracking users via the web that does not use cookies.

Invention embodiments include a system, method and computer readable medium configured to track Internet users as they browse web-sites when cookies are disabled or deleted.

At the same time, the demand for multi-media content on the web is increasing. At this point, 96% of all Internet web browsers have an embedded “flash” multi-media player. Such flash players decode and play back multiple streams of compressed audio and video simultaneously. Examples of flash players include, but are not limited to: Adobe Flash™ (from Adobe Systems Incorporated of San Jose, Calif.), Microsoft Silverlight™ (from Microsoft Corporation of Redmond, Wash.), Gnash (from the Free Software Foundation of Boston, Mass.), and Moonlight (from the Mono Project lead by Novell of Waltham, Mass.).

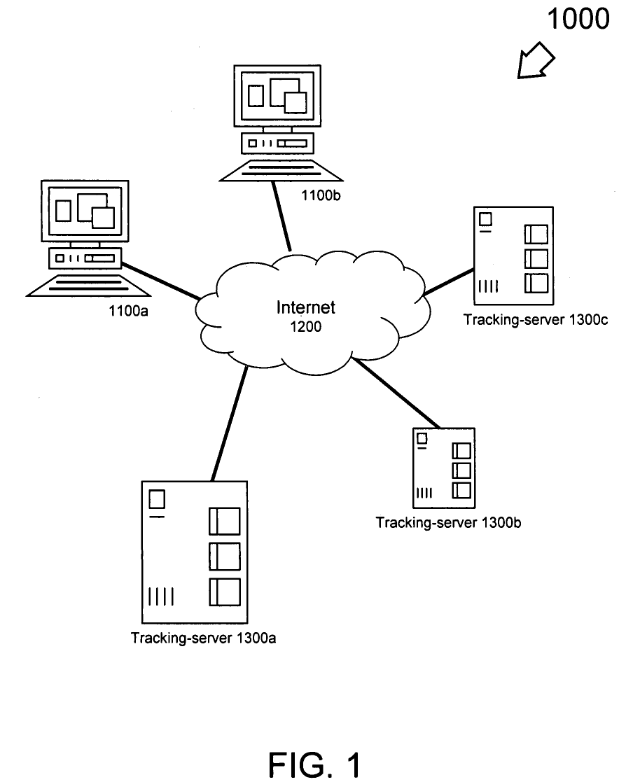

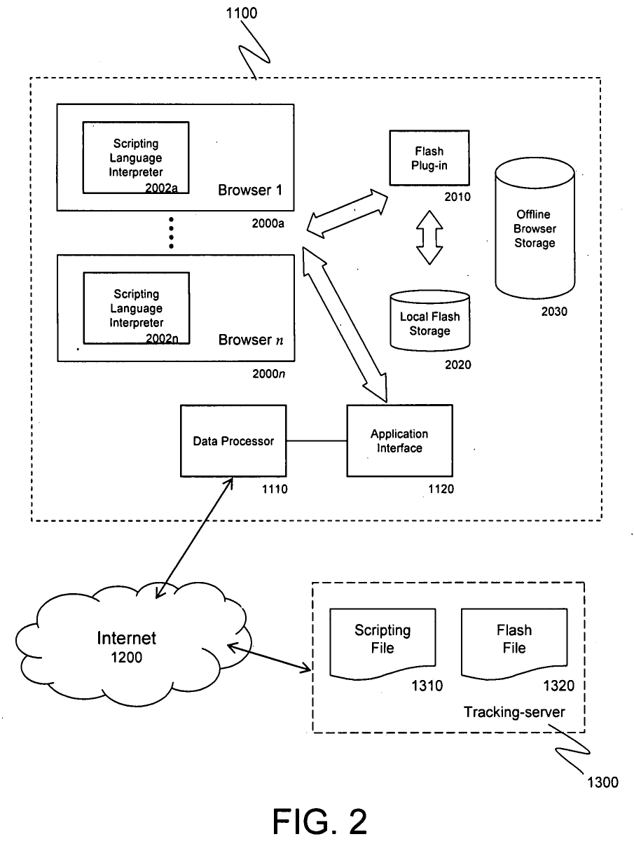

Turning to FIGS. 1 and 2, these figures depict a system 1000 configured to track Internet users as they browse web-sites on the Internet without using cookies, constructed and operative in accordance with an embodiment of the present invention.

As shown in FIG. 1, the system 1000 includes a web-user terminals 1100a-b configured to communicate with tracking servers 1300a-c via a computer network such as the Internet 1200.

For the purposes of this document, web-user terminals 1100 may be any computing device known in the art capable of viewing a web-page or surfing the World-Wide-Web, and are enabled with a multi-media flash player. In some embodiments, web-user terminals 1100 are personal computers connected to a computer network 1200 via a wired connection. In other embodiments, web-user terminals 1100 are wireless mobile devices connected to a computer network 1200 via a WiFi or other wireless network protocol known in the art. Examples include, but are not limited to: notebook computers, personal digital assistants (PDAs), and mobile phones.

Tracking servers 1300 may be any web-server or computer delivering HTML, XML, or multimedia flash content.

Selected internal components of system 1000 are shown in FIG. 2, depicting an expanded version of a web-user terminal 1100 and tracking-server 1300. Embedded within a processor or central processing unit of web-user terminal 1100, is a data processor 1110, an application interface 1120, and one or more web browsers 2000a-n. Web browsers 2000a-n have access to a scripting language interpreter 2002, flash plug-in 2010, local flash storage 2020, and offline browser storage 2030. Some or all of these structures may be stored on a computer-readable medium, as is known in the art.

Data processor 1110 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Data processor 1110 allows web-user terminal 1100 to communicate with tracking-server 1300.

Application interface 1120 enables web-user terminal 1100 to take some action with respect to a separate software application or entity. For example, application interface 1120 may take the form of a graphical-user or windowing interface, as is commonly known in the art. An example of an application interface includes, but is not limited to: Microsoft Windows, X-Windows, Motif, OpenWindows, and the Apple Macintosh OpenStep user interface.

Web browsers 2000a-n are any software application that enables a user to display and interact with text, images, and other information typically located on a Web page at a website on the World Wide Web or a local area network. Web-browsers include Internet Explorer, Mozilla Firefox, Apple Safari, Opera, and Netscape.

Scripting language interpreter 2002 is any structure that allows web browser 2000 to execute a scripting file 1310 written in a computer scripting language such as Dynamic HTML, Jscript, JavaScript, ECMAScript, Tcl, or VBScript.

As described above, a flash player decodes and plays back multiple streams of compressed audio and video simultaneously. A flash plug-in 2010 is any plug-in, code, program, or applet that enables flash functionality within web browser 2000. Local flash storage 2020 is any local storage accessible by flash plug-in 2010 as storage, including but not limited to persistent identification elements (“PIE”) or local shared object (“LSO” or “.sol”) files.

Offline browser storage 2030 provides string key/value pairs which may be securely stored and later retrieved for use. Offline browser storage 2030 provides a comprehensive structure through which interactive applications may be built (including advanced abilities, such as being able to work “offline” for extended periods of time). An example of offline browser storage 2030 is DOM Storage, which is the set of storage-related features introduced in the Web Applications 1.0 and implemented in Mozilla-based browsers, such as Firefox 2.

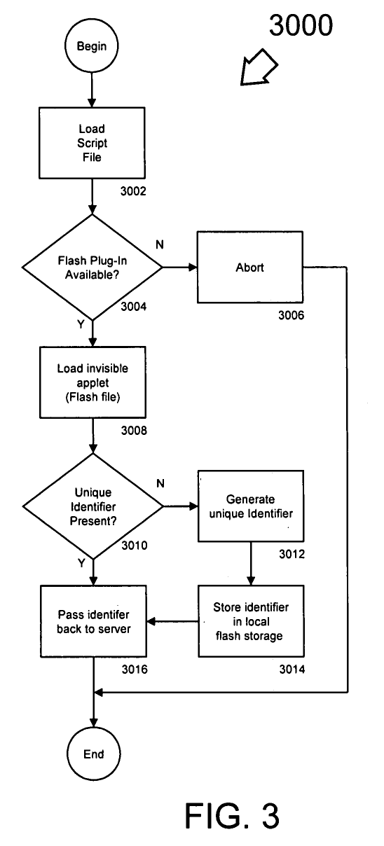

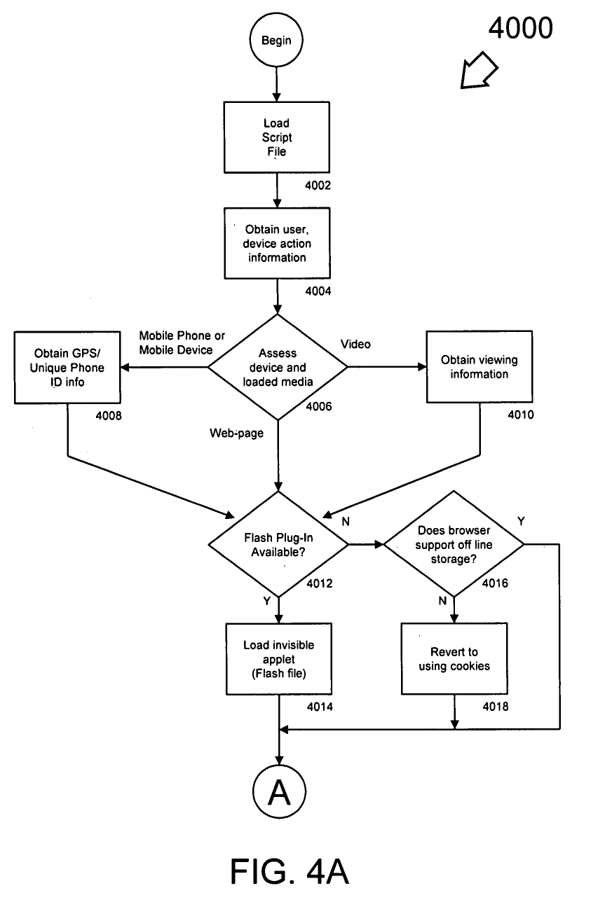

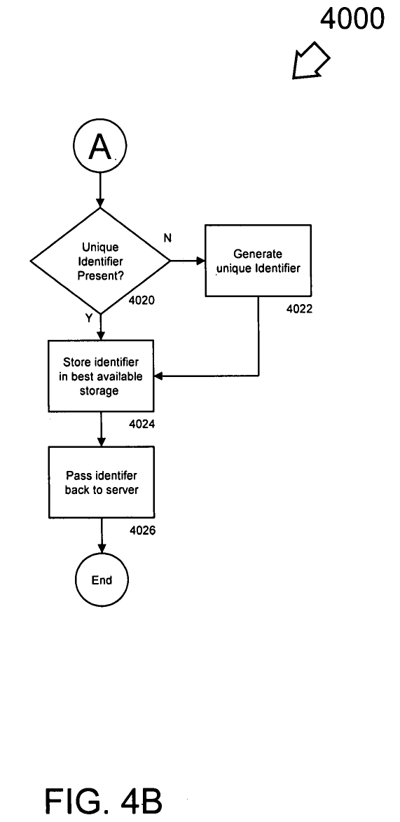

The function of these structures may best be understood with respect to the flowchart of FIGS. 3 through 4A and 4B, as described below.

FIG. 3 illustrates a first process embodiment 3000 configured to track Internet users as they browse web-sites on the Internet without using cookies, constructed and operative in accordance with an embodiment of the present invention. The flowchart of FIG. 3 depicts process 3000 from the perspective of web-user terminal 1100. It is understood that by examining FIG. 3, one of ordinary skill in the art would appreciate and understand the same process from the perspective of the tracking server 1300.

Initially process 3000 begins as a user on web-user terminal 1100 surfs to a web-site at tracking server 1300. When the browser 2000 downloads the web-page, it also loads a scripting file 2050, which is embedded within the HTML, block 3002. Scripting file 2050 implements a portion of process 3000, and may conceivably be written in any client-side computer scripting language known in the art, and may be commonly found written in Dynamic HTML, Jscript, JavaScript, ECMAScript, Tcl, or VBScript. Scripting file may then be executed by browser 2000.

At decision block 3004, browser 2000 determines whether it has access to a flash plug-in 2010. If no flash plug-in 2010 is available, process 3000 reverts to using conventional cookies, block 3006, to track the web-user terminal 1100.

When a flash plug-in 2010 is available, browser 2000 loads flash file 1320 from tracking server 1300. Flash file 1320 may be an applet not visible to the browser 2000 user. Flash file 1320 checks if a unique identifier has been stored in local flash storage 2020, decision block 3010.

If the unique identifier exists, it is sent back to the tracking-server 1300 for tracking, block 3016.

If no unique identifier exists, the identifier is generated. There are many ways of generating such an identifier, block 3012. An identifier may be generated based a hash of the internet protocol (IP) address of the web-user terminal 1100 and the current time, for example. In some embodiments, the identifier generated is based on browser configuration, time of day and a random number generator. The identifier is stored in local flash storage 2020, block 3014, and passed back to the server, block 3016. Process 3000 then ends.

FIGS. 4A-B depict an alternate and more elaborate method embodiment 4000 configured to track Internet users as they browse web-sites on the Internet, constructed and operative in accordance with an embodiment of the present invention.

Similar to process 3000, process 4000 initially begins as a user on web-user terminal 1100 surfs to a web-site at tracking server 1300. The browser 2000 downloads the web-page, also loading a scripting file 2050, embedded within the HTML, block 4002. Scripting file 2050 contains instructions when executed by browser 2000 implements elements of process 4000. As mentioned above, the scripting file 2050 may conceivably be written in any client-side computer scripting language known in the art.

At block 4004, browser 2000 obtains user and device 1100 information. This information may be used to appropriately scale process 4000 to the appropriate device, as assessed at decision block 4006. For example, if web-user terminal 1100 is a mobile phone, a scaled mobile web page may be presented.

If the web-user terminal 1100 is a mobile phone or other wireless mobile device, a unique phone ID (such as the phone's global positioning system (GPS) identifier) is retrieved block 4008, and flow continues at block 4012. If the media being viewed is a video, the viewing information is obtained, block 4010, and flow continues at block 4012. If the media being viewed is a web-page, flow continues at block 4012.

At decision block 4012, browser 2000 determines whether it has access to a flash plug-in 2010.

When a flash plug-in 2010 is available, browser 2000 loads flash file 1320 from tracking server 1300. Flash file 1320 may be an applet not visible to the browser 2000 user. Flow continues at block 4020.

If at decision block 4012 no flash plug-in 2010 is available, process 3000 determines whether the browser 2000 supports off-line storage 2030, block 4016. If not process 4000 reverts to using conventional cookies, block 4018, to track the web-user terminal 1100.

At block 4020, flash file 1320 checks if a unique identifier has been stored in local flash storage 2020, cookies, or in off-line storage 2030. If the unique identifier exists, it is sent back to the tracking-server 1300 for tracking, block 3016.

If no unique identifier exists, the identifier is generated. As discussed above, there are many ways of generating such an identifier, block 4022.

The identifier is stored in local flash storage 2020, block 4024, and passed back to the server, block 4216. Process 3000 then ends.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1. A method of tracking visits by a computing-device to a web-site comprising:
receiving a request for content from the computing-device;
obtaining information about the computing-device;
assessing the request for content from the computing-device;
determining whether the computing-device has an available flash plug-in;
transmitting a flash applet to the computing-device when the flash plug-in is available, the flash applet configured to:
determine whether a unique flash identifier has been assigned to the computing-device;
generate the unique flash identifier if no unique flash identifier has already been assigned to the computing-device;
transmit the unique flash identifier to a tracking server;
store the unique flash identifier in local flash storage;
storing a cookie at the computing-device when no flash plug-in is available.

2. The method of claim 1, wherein the information obtained about the computing device is used to generate the unique flash identifier.

3. The method of claim 2, wherein the flash plug-in is Adobe Flash or Microsoft Silverlight.

4. The method of claim 3, further comprising:
generating a unique identifier when no flash plug-in is available; and
storing the unique identifier in offline browser storage.

5. The method of claim 4, further comprising:
transmitting the cookie to a tracking server if the cookie exists at the computing-device.

6. The method of claim 4, further comprising:
transmitting the unique identifier to a tracking server if the unique identifier exists at the computing-device.

7. A tracking-server configured to tracking visits by a computing-device to a web-site comprising:
means for receiving a request for content from the computing-device;
means for obtaining information about the computing-device;
means for assessing the request for content from the computing-device;
means for determining whether the computing-device has an available flash plug-in;
means for transmitting a flash applet to the computing-device when the flash plug-in is available, the flash applet configured to:
determine whether a unique flash identifier has been assigned to the computing-device;
generate the unique flash identifier if no unique flash identifier has already been assigned to the computing-device;
transmit the unique flash identifier to the tracking server;
store the unique flash identifier in local flash storage;
means for storing a cookie at the computing-device when no flash plug-in is available.

8. The tracking server of claim 7, wherein the information obtained about the computing device is used to generate the unique flash identifier.

9. The tracking server of claim 8, wherein the flash plug-in is Adobe Flash or Microsoft Silverlight.

10. The tracking server of claim 9, further comprising:
means for generating a unique identifier when no flash plug-in is available; and
means for storing the unique identifier in offline browser storage.

11. The tracking server of claim 10, further comprising:
means for transmitting the cookie to a tracking server if the cookie exists at the computing-device.

12. The tracking server of claim 10, further comprising:
means for transmitting the unique identifier to a tracking server if the unique identifier exists at the computing-device.

13. A method of tracking visits by a computing-device to a web-site comprising:
determining whether the computing-device has an available flash plug-in;
determining whether a unique flash identifier has been assigned to the computing-device;
generating the unique flash identifier if no unique flash identifier has already been assigned to the computing-device;
transmitting the unique flash identifier to a tracking server; and
storing the unique flash identifier in local flash storage.
